(19) United States
(12) Patent Application Publication
(10) Pub. No.: US 2008/0111291 A1
(43) Pub. Date: May 15, 2008

(54) Swiss Turning Machine Work Piece Holding Apparatus and Method

(76) Inventors: Joseph R. Navarro, Lincolnton, NC (US); Mariam M. Navarro, Lincolnton, NC (US)

Correspondence Address: ROBERT J. YARBROUGH, ATTORNEY AT LAW, 201 NORTH JACKSON STREET, MEDIA, PA, 19063, US

(21) Appl. No.: 11/936,547

(22) Filed: Nov. 7, 2007

Related U.S. Application Data
(60) Provisional application No. 60/858,037, filed on Nov. 9, 2006.

(51) Int. Cl. B23Q 1/25; B23B 3/00

(52) U.S. Cl. 269/55; 82/152

(57) ABSTRACT

The Invention is an improved work holding apparatus and method for a Swiss turning machine. A tube selectably bears upon the apron of a collet. A belt crank selectably bears upon the tube and a conical actuator selectably bears upon the bell crank. Movement of the conical actuator along its longitudinal axis is translated by the bell crank into longitudinal motion of the tube causing the collet to engage or disengage the work piece. The improvement of the Invention is to make the engagement between the conical actuator and the bell crank a rolling engagement. The improvement of the Invention is also to provide a wear member for the tube-engaging portion of the bell crank.

### BACKGROUND OF THE INVENTION

A. Field of the Invention

The invention is an improved work piece holding apparatus and method for a Swiss-type machine tool. The improved work piece holding apparatus of the Invention substantially increases the time between necessary maintenance and improves accuracy and consistency of machine production.

B. Background of the Invention

Swiss turning machines (also known as “Swiss screw machines” and “Swiss-type machines”) are popular for volume production of machined metal parts. Swiss turning machines were originally used for producing relatively long, relatively thin parts in watch manufacture. A modern Swiss turning machine may operate in several axes and may perform several different computer numerically controlled (“CNC”) machining operations. In the Swiss turning machine, the work piece is a bar of metal or other material to be machined. The metal bar stock is fed into the machine and selectably retained by a collet. The machine spins the bar stock work piece and moves the spinning work piece against a stationary cutting tool. Additional operations may be conducted on the work piece, such as milling, drilling and boring, while the work piece is held in the collet.

A crucial aspect of the Swiss turning machine, or any other machine tool, is consistency. A machine tool will perform the same operation in the same way many times. To turn out machined parts that are consistent and that hold fine tolerances, the dimensions of the machine tool must be the same for each part produced. If the toot changes dimensions because of thermal expansion, the parts will not be consistent. If the toot changes dimensions because of wear, the parts will not be consistent. Secure retention of the work piece by the collet is crucial to consistent operation of a Swiss turning machine.

In the Swiss turning machine, bar stock passes through the collet and through a tube that selectably engages the collet. An actuator having a generally conical actuating surface engages a bell crank, selectably moving the bell crank about a bell crank bearing between a first and second position. As the belt crank moves about the bearing between the first and the second position, a tube-engaging portion of the bell crank engages or disengages the tube, moving the tube into and out of engagement with the collet and hence selectably gripping or releasing the work piece. When the bell crank or conical actuator wears in the prior art Swiss turning machine, the tube is not moved as far in the longitudinal direction and the collet does not grip the work piece as effectively. The lack of an effective grip on the work piece can cause the work piece to move in the collet, destroying consistency and adversely affecting the quality of the product.

A typical prior art Swiss turning machine has three or more bell cranks engaging the conical actuator. The bell cranks currently are composed of a relatively soft material so that wear is concentrated in the bell crank rather than the actuator. Because of rapid wear, the bell cranks must be replaced regularly. Replacement of a set of bell cranks currently requires that the Swiss turning machine be taken out of operation for about two hours. A set of replacement bell cranks costs about $300.00. Replacement of the conical actuator requires that the Swiss turning machine be out of operation for two full days. A replacement conical actuator costs about $500.00 to $600.00.

### BRIEF DESCRIPTION OF THE INVENTION

The invention is an improvement to the work piece holding mechanism of a Swiss turning machine. The Invention provides a roller on the bell crank for engagement with the actuating surface of the conical actuator. The roller serves to change the sliding engagement between the bell crank and conical actuator into a rolling engagement. The rolling engagement substantially reduces friction between the conical actuator and the bell crank. Wear of both the bell crank and the actuator is substantially reduced, reducing the need to replace the bell crank or the actuator. The most rapidly wearing part in the improved mechanical train is the roller. Changing a set of rollers may be completed within half of an hour, minimizing machine downtime. The cost of rollers also is nominal, decreasing maintenance costs. Because of the rolling engagement between the roller and the conical actuator, the roller may be composed of relatively hard materials without increasing the rate of wear of the conical actuator. The service life of the rollers therefore is significantly increased compared to the service life of the prior art bell crank and the overall maintenance requirements of the work piece holding assembly are reduced.

A second wear point in the work-holding mechanical train of the Swiss turning machine is the engagement between the tube-engaging portion of the bell crank and the tube. Experience has shown that wear of the tube-engaging portion of the prior art bell crank is small compared to the wear of the prior art actuator-engaging portion, and that the use of a roller for engagement between the bell crank and the actuator substantially extends the life of the mechanical train. Nonetheless, a second aspect of the Invention provides for the tube-engaging portion of the bell crank to comprise a replaceable wear member disposed within a suitable opening in the bell crank. The material from which the wear member is composed is selected to be softer than the material from which the tube is composed so that wear from the engagement between the bell crank and the tube is concentrated in the wear member. When the wear member becomes worn, a set screw retaining the wear member is turned, releasing the wear member. The wear member then is removed and replaced with a new wear member and the set screw is tightened, securing the wear member in position. The wear member and opening are configured so that the wear member does not turn within the opening; for example, the wear member may be equipped with a dovetail or have a cross section that is other than circular. As an alternative to the set screw, the wear member may be a press fit into the opening. Other mounting means of the wear member within the wear member opening are available.

### BRIEF DESCRIPTION OF THE DRAWINGS

FIG. 1 is a detail cross section of the collet and tube of the Invention.

FIG. 2 is a detail cross section of the tube, conical actuator and bell crank.

FIG. 3 is a detail partial cutaway side view of the bell crank.

FIG. 4 is a detail partial cutaway top view of the bell crank.

### DESCRIPTION OF AN EMBODIMENT

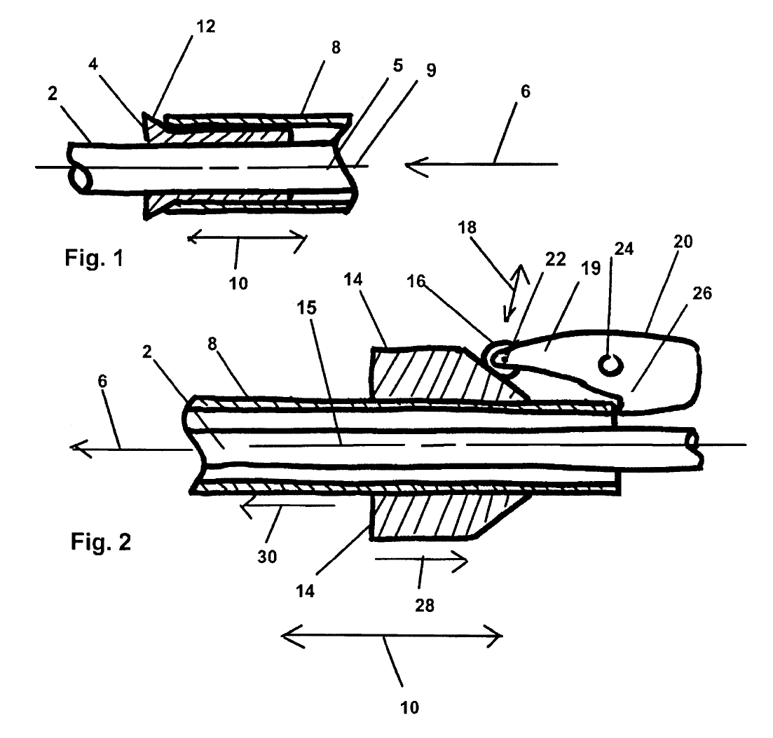

FIGS. 1 and 2 are detail cross sections of components within a Swiss turning machine. From FIGS. 1 and 2, the Invention relates to the handling of the work piece 2 within the Swiss turning machine. A collet 4 selectably grips a work piece 2, such as metal bar stock. Collet 4 has a longitudinal axis 5. The work piece 2 extending from the collet 4 is acted upon by the cutting tools of the Swiss turning machine. To feed additional bar stock into the Swiss turning machine to form a new work piece 2, collet 4 releases its grip on work piece 2 and the work piece 2 moves along collet longitudinal axis 5 in the direction indicated by arrow 6.

The mechanism to selectably cause collet 4 to grip or release work piece 2 is addressed by the Invention and includes tube 8. Tube 8 has a tube longitudinal axis 9 that is collinear with collet longitudinal axis 5. Work piece 2 passes through tube 8 and collet 4. Tube 8 surrounds collet 4. Tube 8 selectably can move along the tube longitudinal axis 9 in the direction indicated by arrow 10 between a first tube position and a second tube position. When tube 8 is in the first position, tube 8 presses against apron 12 of collet 4, thereby closing collet 4 and causing collet 4 to grip work piece 2.

To release the work piece 2 from collet 4, tube 8 moves along tube longitudinal axis 9 until tube 8 does not press on apron 12. When the tube 8 is in this second tube position, collet 4 does not grip work piece 2 and the work piece 2 is free to move in the feed direction indicated by arrow 6.

The mechanism for moving the tube 8 in the longitudinal direction 10 between the first, or engaged position, and the second, or disengaged position, is illustrated by FIG. 2. The tube 8 passes through an opening in a conical actuator 14. Conical actuator 14 has an actuator longitudinal axis 15 that is collinear with tube longitudinal axis 9 and collet longitudinal axis 5. Conical actuator 14 is movable along the actuator longitudinal axis 15 in the directions indicated by line 10 with respect to tube 14 between a first actuator position and a second actuator position.

A roller 16 engages conical actuator 14 and is moved in a generally axial direction indicated by arrows 18 as the actuator 14 moves in a longitudinal direction 10 between the first actuator position and the second actuator position. The roller 16 is connected to actuator-engaging portion 19 of bell crank 20 by axle 22. The bell crank 20 rotates about a bell crank bearing 24 as the roller 16 is moved by the actuator 14. The bell crank 20 therefore translates motion of the roller 16 in an axial direction 18 into motion by a tube-engaging portion 26 in the longitudinal direction 10.

The tube-engaging portion 26 of the bell crank 20 engages the tube 8 and moves the tube in the longitudinal direction 10 in response to motion of the actuator 14. The motion of the tube 8 in the longitudinal direction 10 engages or disengages the collet 4, selectively holding or releasing the work piece 2.

Motion by the actuator 14 in the direction indicated by arrow 28 therefore is translated into motion by the tube 8 in the direction indicated by arrow 30, causing the collet 4 to grip the work piece 2. Motion of the actuator 14 between the first actuator position and the second actuator position thereby moves the tube 8 between the first tube position and the second tube position, causing the collet 4 to either grip or release the work piece 2.

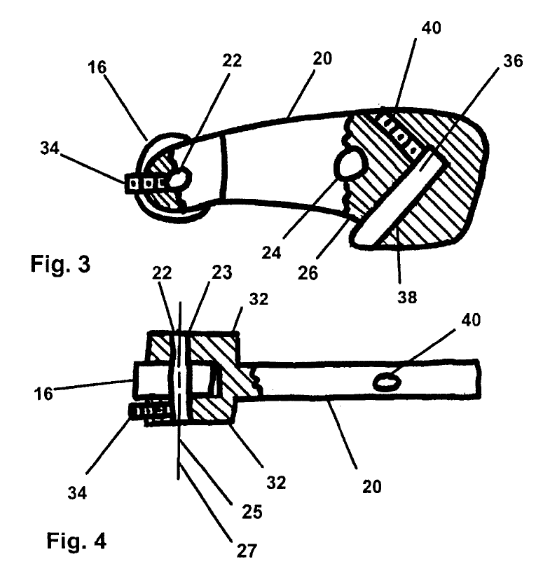

FIG. 3 is a detail partial cutaway side view of the bell crank 20. FIG. 4 is a detail partial cutaway top view of bell crank 20. From FIGS. 3 and 4, bosses 32 support axle 22 in an axle opening 23. Axle 22 has an axle longitudinal axis 25. Roller 16 has a roller axis of rotation 27, which is collinear with axle longitudinal axis 25. Bosses 32 are located in a spaced-apart arrangement and support roller 16. Roller 16 is configured for rotation on axle 22. Axle set screw 34 selectably retains axle 22 in place. To replace rollers 16, an operator loosens axle set screw 34 and removes axle 22 and roller 16. The operator reverses the process to install a new roller 16.

Roller 16 may be rotatably attached to bell crank 16 in any manner known in the art. For example, axle 22 may be a press fit within bosses 32, in which event axle set screw 34 is not required. Axle 22 may be fixed to roller and configured to rotate within bearings located in bosses 32, in which event one or both bosses 32 may be removable. A single boss 32 may be used and axle 22 supported on only one side. Roller 16 may be trapped roller within a cage on bell crank 20, in which event axle 22 is not required.

As shown by FIG. 3, tube-engaging portion 26 of bell crank 20 may comprise a wear member 36. Wear member 36 is disposed within a mating opening 38 in bell crank 20. Wear member 36 and mating opening 38 are configured so that wear member 36 does not turn in opening 38. Wear member 36 is retained in opening 38 by wear member set screw 40.

Wear member 36 may be mounted to bell crank 20 by any means known in the art. As examples, wear member 36 may be a press fit within mating opening 38, in which event wear member set screw 40 is not required. Mating opening 38 may be a through hole or may appear in a side of the belt crank 20, in which event wear member 36 may be replaced without dismounting bell crank 20 from the Swiss turning machine. Wear member 36 also may be mounted in bell crank 20 in a threaded mating opening 38, which may be a through hole, or may be retained in mating opening 38 by a threaded fastener having an axis of rotation coincident with a longitudinal axis of wear member 36, in which event wear member 36 may be adjusted by turning wear member 36 or threaded fastener within the threaded mating opening 38.

In describing the above embodiments of the invention, specific terminology is selected for the sake of clarity. However, the invention is not intended to be limited to the specific terms so selected, and it is to be understood that each specific term includes all technical equivalents that operate in a similar manner to accomplish a similar purpose.

I claim:

1. An improved work holding apparatus of a Swiss turning machine of the type having a collet selectably engaging a work piece, a tube selectably engaging an apron of the collet and effecting the selectable engagement of the collet with the work piece, a bell crank selectably engaging the tube and effecting the selectable engagement of the tube with the apron of the collet, and a conical actuator in a selectable engagement with the bell crank and effecting the selectable engagement of the bell crank with the tube, the improvement comprising: means for providing a rolling engagement between the conical actuator and the bell crank.

2. The improved work holding apparatus of claim 1 wherein said means for providing said rolling engagement comprising: a roller, the bell crank defining a conical actuator-engaging portion, said roller rotatably engaging said conical actuator-engaging portion of the bell crank, said roller being in a rolling engagement with said conical actuator.

3. The improved work holding apparatus of claim 2 further comprising: an axle, said axle defining an axle longitudinal axis, said roller defining a roller axis of rotation, said roller axis or rotation being coincident with said axle longitudinal axis, said roller being rotatable about said axle, said axle engaging and being supported by said actuator-engaging portion of the bell crank.

4. The improved work holding apparatus of claim 3, the apparatus further comprising: an axle opening defined by said actuator-engaging portion of the bell crank, said axle penetrating said axle opening, said axle being fixed within said axle opening with respect to said actuator-engaging portion of the bell crank.

5. The improved work holding apparatus of claim 4, the apparatus further comprising: an axle set screw, said axle set screw penetrating said actuator-engaging portion of the bell crank, said axle set screw bearing upon said axle and fixing said axle in said axle opening.

6. The improved work holding apparatus of claim 4 wherein said actuator-engaging portion of the bell crank defines a pair of bosses located in a spaced-apart relation, said pair of bosses defining said axle opening, said axle extending between said pair of bosses, said roller being supported between said pair of bosses by said axle.

7. The improved work holding apparatus of claim 3, the apparatus further comprising: a wear member, the bell crank defining a tube engaging portion, said wear member being attached to said tube-engaging portion of the bell crank, said wear member selectably bearing upon the tube.

8. The improved work holding apparatus of claim 7, the apparatus further comprising:
a. a wear member opening defined by said tube-engaging portion of the bell crank, said wear member penetrating said wear member opening;
b. a wear member set screw, said wear member set screw penetrating said tube-engaging portion of the bell crank, said wear member set screw bearing upon said wear member, said wear member set screw fixing said wear member in said wear member opening.

9. A method for holding a work piece in a Swiss turning machine, the method comprising:
a. Locating a work piece in a collet, said collet having a collet longitudinal axis, said collet having a apron;
b. providing a tube, said tube having a tube longitudinal axis, said tube longitudinal axis being collinear with said collet longitudinal axis, said tube being selectably movable along said tube longitudinal axis between a first tube position and a second tube position, said tube bearing upon said apron of said collet when said tube is in said first tube position to close said collet about the work piece, said tube not bearing on said apron of said collet to close said collet when said tube is in said second tube position;
c. providing a conical actuator, said conical actuator having a conical actuator longitudinal axis, said conical actuator longitudinal axis being collinear with said collet longitudinal axis, said conical actuator being movable along said conical actuator longitudinal axis between a first conical actuator position and a second conical actuator position;
d. providing a bell crank, said bell crank being rotatable about a bell crank bearing between a first bell crank position and a second bell crank position, said first bell crank position corresponding to said first actuator position, said second bell crank position corresponding to said second actuator position, said bell crank having an actuator-engaging portion;
e. providing a roller, said roller rotatably engaging said actuator-engaging portion of said bell crank, said roller being in rolling engagement with said conical actuator, said conical actuator selectably urging said roller and said bell crank between said first bell crank position and said second bell crank position, said bell crank having a tube-engaging portion, said tube-engaging portion engaging said tube, said bell crank when in said first bell crank position urging said tube into engagement with said apron of said collet and thereby closing said collet and securing the work piece, said bell crank when in said bell crank second position releasing said tube from engagement with said apron of said collet and releasing said work piece from said collet;
f. moving said conical actuator from said second actuator position to said first actuator position, thereby selectably retaining the work piece in said collet.

10. The method of claim 9, the method further comprising: providing an axle, said axle defining an axle longitudinal axis, said roller defining a roller axis of rotation, said roller axis or rotation being collinear with said axle longitudinal axis, said roller being rotatable about said axle, said axle engaging and being supported by said conical actuator engaging portion of said bell crank.

11. The method of claim 10, the method further comprising: providing a pair of bosses defined by said actuator-engaging portion of said bell crank, said pair of bosses being located in a spaced-apart relation, said pair of bosses defining an axle opening, said axle penetrating said axle opening, said axle extending between said pair of bosses, said roller being supported between said pair of bosses.

12. The method of claim 11, the method further comprising: providing a wear member, said wear member being attached to said tube-engaging portion of the bell crank, said wear member selectably bearing upon said tube, said wear member being replaceable.

13. The method of claim 12, the method further comprising: providing an axle set screw, said axle set screw penetrating a one of said pair of bosses, said axle set screw bearing upon said axle, said axle set screw fixing said axle within said axle opening.
